(19) United States
(12) Patent Application Publication
(10) Pub. No.: US 2013/0113597 A1
(43) Pub. Date: May 9, 2013

(54) TRANSFORMER WITH SHIELDED CLAMPS

(71) Applicant: ABB Technology AG, Zurich (CH)

(72) Inventors: Carlos ROY, Zaragoza (ES); Rafael Murillo, Zaragoza (ES); Jens Tepper, Brilon (DE); Jasmin Smajic, Schofflisdorf (CH); Jesús Letosa Fleta, Zaragoza (ES); Antonio Usón, Zaragoza (ES); Maria Teresa Villén, Zaragoza (ES); Miguel Samplón, Zaragoza (ES)

(73) Assignee: ABB Technology AG, Zurich (CH)

(21) Appl. No.: 13/721,670

(22) Filed: Dec. 20, 2012

Related U.S. Application Data
(63) Continuation of application No. PCT/EP2011/060299, filed on Jun. 21, 2011.

(30) Foreign Application Priority Data
Jun. 28, 2010 (EP) 10167493.5

(51) Int. Cl. H01F 27/28

(52) U.S. Cl. CPC H01F 27/2885
USPC 336/84 C

(57) ABSTRACT

The present disclosure provides for the shielding of clamps of a transformer, and including an electric shielding arrangement for a transformer and a transformer with the arrangement. An electric shielding arrangement for a transformer is provided, with a clamp which is attached at a yoke and stabilizes the yoke of the transformer. The arrangement includes an electric shielding device arranged at the clamp between the yoke and a winding of the transformer and having a trough-like form. The electric shielding device may have the form of a rounded cover and is configured to shield the clamp from an electric field of the winding.

### RELATED APPLICATIONS

This application claims priority as a continuation application under 35 U.S.C. §120 to PCT/EP2011/060299, which was filed as an International Application on Jun. 21, 2011 designating the U.S., and which claims priority to European Application 10167493.5 filed in Europe on Jun. 28, 2010. The entire contents of these applications are hereby incorporated by reference in their entireties.

### FIELD

The present disclosure relates to the shielding of clamps of transformers. More particularly, the present disclosure relates to an electric shielding arrangement for a transformer, and a transformer including the arrangement.

### BACKGROUND INFORMATION

Transformers may be widely used for low, medium, and high voltage applications.

In dry type transformers, the high voltage to clamp insulation may be made by an airspace between the high voltage surrounded by solid insulation (e.g. casted) and the clamp surface being bare or insulated by some films. Support blocks for coils are also placed between the clamps and the coils. The clamps may include tie rods, balls, nuts, and welded steel and include several sharp metallic edges.

Carbon steel clamps may be used in dry transformers. The clamps may have a U-profile or may have the form of a bended plate. In some cases, the clamps show polished edges to avoid the sharp edges, leading to an equivalent radii of about 1-3 mm (for oil and dry transformers). The clamp side facing the windings may be bare or insulated by some films.

### SUMMARY

An exemplary embodiment of the present disclosure provides an electric shielding arrangement for a transformer. The exemplary arrangement includes a clamp attached at a yoke of the transformer and configured to stabilize the yoke of the transformer. The exemplary arrangement also includes an electric shielding device arranged at the clamp, between the yoke and a winding of the transformer. The electric shielding device is configured to shield the clamp from an electric field of the winding.

An exemplary embodiment of the present disclosure provides a transformer which includes the above-described arrangement, at least two limbs, a winding arranged around at least one of the at least two limbs, and a first yoke connecting the at least two limbs.

### BRIEF DESCRIPTION OF THE DRAWINGS

Additional refinements, advantages and features of the present disclosure are described in more detail below with reference to exemplary embodiments illustrated in the drawings.

FIG. 1 schematically shows a cross-sectional view of a transformer with an electric shielding arrangement according to an exemplary embodiment of the present disclosure.

FIG. 2 schematically shows an electric shielding arrangement according to an exemplary embodiment of the present disclosure.

FIG. 3 schematically shows a perspective view of the bottom of a transformer with an electric shielding arrangement according to an exemplary embodiment of the present disclosure.

FIG. 4 schematically shows a perspective view of the top of the transformer of FIG. 3.

The reference symbols used in the drawings, and their meanings, are listed in summary form in a list of reference symbols. In principle, identical or similarly functioning parts are provided with the same reference symbols in the figures.

### DETAILED DESCRIPTION

Exemplary embodiments of the present disclosure increase the dielectric strength of a transformer.

In accordance with an exemplary embodiment, the dielectric strength of a transformer is increased by an electric shielding arrangement and by a transformer as described herein.

According to an exemplary embodiment of the present disclosure, an electric shielding arrangement for a transformer is provided with a clamp attached at a yoke and stabilizing the yoke of the transformer, and an electric shielding device. The electric shielding device is arranged at the clamp between the yoke and a winding of the transformer. The electric shielding device is configured to shield the clamp from an electric field of the winding.

In other words, a cover may be placed on a clamp facing the winding, and the cover may act as an electrostatic shield and/or as a protective shield in order to shield the sharp edges of the clamp itself and all other metallic edges related to the clamp, thereby smoothing the electric field of the transformer with respect to the clamps. In accordance with an exemplary embodiment, the shielding cover is kept bare, not covered by any insulation film. The shielding cover may be insulated according to another exemplary embodiment of the present disclosure. The clamp is configured to hold together and/or mechanically fix or stabilize a yoke of the transformer to the coil(s) of the transformer. The electric shielding device may cover the clamp and/or may have a vat- or trough-like form covering the clamp. The yoke is configured to connect at least two limbs. More than one yoke may be provided. The winding may be arranged around at least one of the at least two limbs.

The above mentioned electric shielding device arrangement is applicable to dry transformers with a voltage level above 70 kV effectively shielding the clamp of the dry transformer from the electric field generated by the winding of the dry transformer. Thus, a dry transformer with HV winding designed as HV disc winding with a voltage level of 70 kV and above may be built as compact as a dry transformer with a lower voltage level. There may be higher field strength in the critical region between the HV winding and the clamp and particularly higher field peaks at the HV disc winding and the edges of the clamp as compared to a dry transformer with a voltage level below 70 kV requiring a higher dielectric strength. This required higher dielectric strength may be provided by the electric shielding device which may homogenize the electric field to the ground such that the clamp is prevented from overheating or losing its required mechanical strength due to discharges of the electric field to the edges of the clamp by the electric shielding device.

The electric shielding device may include a material selected from the group consisting of steel, and aluminium, and generally any conducting material with stabilizing mechanical properties.

The electric shielding device may increase the breakdown voltage and may lead to a 25% improvement of shielding between winding of the transformer coil and the clamps compared to clamps without a electric shielding device according to impulse voltage tests.

The clamp may have rounded edges forming a rounded clamp that may have the function of the electric shielding device, shielding the clamp from an electric field generated by the winding or windings of the transformer. According to an exemplary embodiment of the present disclosure, the rounded clamp is provided without an electric shielding device.

According to an exemplary embodiment of the present disclosure, the electric shielding device includes rounded edges. Such an electric shielding device with rounded edges may smooth an electric field of the winding of a transformer with respect to the transformer clamp by avoiding field peaks or discharges at edges of the clamp, thus preventing the clamp from overheating or losing its required mechanical strength.

According to an exemplary embodiment of the present disclosure, the form of the electric shielding device may be trough-like with rounded edges at the edges of the trough-like electric shielding device.

According to an exemplary embodiment of the present disclosure, the rounded edges of the arrangement include first rounded edges at a longitudinal side of the clamp facing the winding of the transformer. By providing first rounded edges at a longitudinal side of the clamp such that the first rounded edges are facing the winding of a transformer, the clamp may be effectively shielded from the electric field generated in the winding by essentially avoiding electric field peaks that would possibly occur if the (sharp) edges of the electric shielding device at the longitudinal side of the clamp would be not rounded. Thus, the mechanical strength of the clamp at its longitudinal side or at the side where the clamp is stabilizing the yoke of the transformer may be ensured and not be lost by overheating the clamp due to discharges from the electric field to (sharp) edges of the electric shielding device.

According to an exemplary embodiment of the present disclosure, the rounded edges of the arrangement also include second round edges at a first end and at a second end of the electric shielding device at a transverse side of the clamp. The second rounded edges at the first and second end of the electric shielding device at a transverse side of the clamp provides effective shielding of the clamp against an electric field of the winding at the most critical areas of the clamp concerning possible discharges due to the electric field. As described above, electrical field peaks may be avoided by the second rounded edges that would possibly occur if the (sharp) edges of the electric shielding device at the transversal sides of the clamp would be not rounded. Thus, an overheating and losing of the mechanical stability of the clamp at its transversal side due to discharges from the electrical field to (sharp) edges of the electric shielding device may be prevented.

According to an exemplary embodiment of the present disclosure, the first or second rounded edges may have a radius of 5-45 mm, for example, 30 mm. By providing first or second rounded edges of a radius of 5 to 45 mm, the shielding properties of the electric shielding device are improved as compared to first or second rounded edges of a different radius or a radius of 0 mm. For example, a radius of 30 mm for the first and/or second rounded edges provides for an effective shielding of the electric field of the winding to the clamp due to the avoidance of field peaks at possible edges of the electric shielding device and/or the clamp and an effective smoothing of the electric field.

According to an exemplary embodiment of the present disclosure, the first rounded edges have a different radius at a first region at a yoke of the transformer and at a second region that is not at the yoke. Thus, at a first region at a yoke of the transformer depending on the core stacking a smaller radius, for example, a radius of 10 mm, may be provided, and at a second region that is not at the yoke a larger radius, for example, a radius of 30 mm, may be provided ensuring a sufficient optimal shielding of the electric field of the winding to the clamp while enabling an easy mounting of the electric shielding device, for example, in the first region at the yoke, where larger radii could lead to a difficult mounting of the electric shielding device, and a saving of material.

According to an exemplary embodiment of the present disclosure, the electric shielding device is grounded by being connected to the clamp. Such a grounding of the shielding device by connecting the shielding device to the clamp may provide for the clamp being free of an electric field. The electric shielding device is affected by the electric field of the winding and not the clamp.

The connection of the electric shielding device to the clamp may be a screw-thread connection. For example, the electric shielding device may have threaded pines or threaded holes matching with holes in the clamp, such that the electric shielding device may be screwed to the clamp.

According to an exemplary embodiment of the present disclosure, the electric shielding device is welded to the clamp. By welding the electric shielding device to the clamp, an efficient and easy mounting of the electric shielding device to the clamp may be provided as no holes for screw connections may be necessary to fix the electric shielding device to the clamp. Furthermore, an electric shielding device with no recesses or through-holes for fastening the electric shielding device may be provided allowing for better shielding properties as through-holes and recesses may have sharp edges which may cause or abet discharges from the electric field of the winding to the electric shielding device. Thus, a cheaper electric shielding device may be provided as no possible sharp edges of recesses or through-holes have to be rounded.

According to an exemplary embodiment of the present disclosure, the first rounded edges have a length of ⅛ of the circumference of a corresponding sphere defined by the radius of the first rounded edges or in other words the first rounded edges may have a length of ⅛ of a sphere. Such first rounded edges with a length of ⅛ of a sphere may provide for an efficient electric shielding device, for an easy and cheap manufacturing of the electric shielding device and mounting to the clamp, and may enable manufacturing a compact, room saving transformer.

According to an exemplary embodiment of the present disclosure, the arrangement also includes holes for placing support block inserts and pressing bolts of the transformer. The holes may be recesses receiving matching counterparts such as the above mentioned pressing bolts. By providing holes for placing support block inserts and pressing bolts of the transformer in the electric shielding device an easier, more efficient manufacturing of the electric shielding device and an easier, more efficient mounting of the electric shielding device to the clamp may be achieved as no additional holes for mounting the electric shielding device to the clamp are needed, for example. Such additional holes may affect, and particularly decrease the shielding function of the electric shielding device due to possible sharp edges at the holes, for example.

According to an exemplary embodiment of the present disclosure, the electric shielding device projects over edges of the clamp. Thus, the electric shielding device may be configured to shield the clamp from an electric field generated in the winding of the transformer

According to an exemplary embodiment of the present disclosure, a transformer is provided. The transformer includes the arrangement according to any one of the aforementioned embodiments, at least two limbs, a winding arranged around at least one of the at least two limbs, and a first yoke connecting the at least two limbs. Such a transformer with an electric shielding arrangement may effectively shield the clamp of a transformer from the electric field generated by the winding of the transformer. Thus, for example, a dry transformer with HV winding designed as HV disc winding with a voltage level of 70 kV and above may be built as compact as a dry transformer with a lower voltage level. There may be higher field strength in the critical region between the HV winding and the clamp and particularly higher field peaks at the HV disc winding and the edges of the clamp as compared to a dry transformer with a voltage level below 70 kV requiring a higher dielectric strength. This required higher dielectric strength may be provided by the electric shielding device which may homogenize the electric field to the ground such that the clamp is prevented from overheating or losing its required mechanical strength due to discharges of the electric field to the edges of the clamp by the electric shielding device. The following embodiments may all have the aforementioned advantages compared to a transformer without the above and below mentioned electric shielding arrangement.

According to an exemplary embodiment of the present disclosure, the transformer is a dry type transformer.

According to an exemplary embodiment of the present disclosure, the transformer is a dry distribution transformer.

According to an exemplary embodiment of the present disclosure, the transformer is applicable at a 72.5 kV voltage level.

According to an exemplary embodiment of the present disclosure, the transformer is applicable at a level above a 72.5 kV voltage level.

According to an exemplary embodiment of the present disclosure, the transformer is applicable at a level below a 72.5 kV voltage level.

According to an exemplary embodiment of the present disclosure, the electric shielding device of the transformer is arranged on all clamps of the transformer.

In other words, the transformer may include two clamps at the bottom and two clamps at the top, wherein an electric shielding device is arranged at each of the four clamps.

According to an exemplary embodiment of the present disclosure, the transformer is configured to electrically shield high voltage windings to the clamp of the transformer.

According to an exemplary embodiment of the present disclosure, the transformer is configured to electrically shield high voltage and low voltage windings to the clamp of the transformer.

According to an exemplary embodiment of the present disclosure, the transformer is configured to electrically shield low voltage windings to the clamp of the transformer.

According to an exemplary embodiment of the present disclosure, the electric shielding device of the transformer is configured to electrically shield high voltage windings to the clamp of the transformer.

According to an exemplary embodiment of the present disclosure, the electric shielding device of the transformer is configured to electrically shield high voltage and low voltage windings to the clamp of the transformer.

According to an exemplary embodiment of the present disclosure, the electric shielding device of the transformer is configured to electrically shield low voltage windings to the clamp of the transformer.

According to an exemplary embodiment of the present disclosure, the transformer includes three limbs each including a first limb end and a second limb end. The first yoke connects the three limbs at the first limb ends. The transformer also includes a second yoke which connects the three limbs at the second limb ends. The electric shielding arrangement of the transformer includes first clamps attached at the first yoke to stabilize the first yoke, second clamps attached at the second yoke to stabilize the second yoke, first electric shielding devices arranged at the first clamps between the first yoke and three windings, where each of the windings are arranged around each of the three limbs, and second electric shielding devices arranged at the second clamps between the second yoke and the three windings.

According to an exemplary embodiment of the present disclosure, the above-mentioned windings may be high voltage windings or low voltage windings.

These and other aspects of the present disclosure will become apparent from and elucidated with reference to the embodiments described hereinafter.

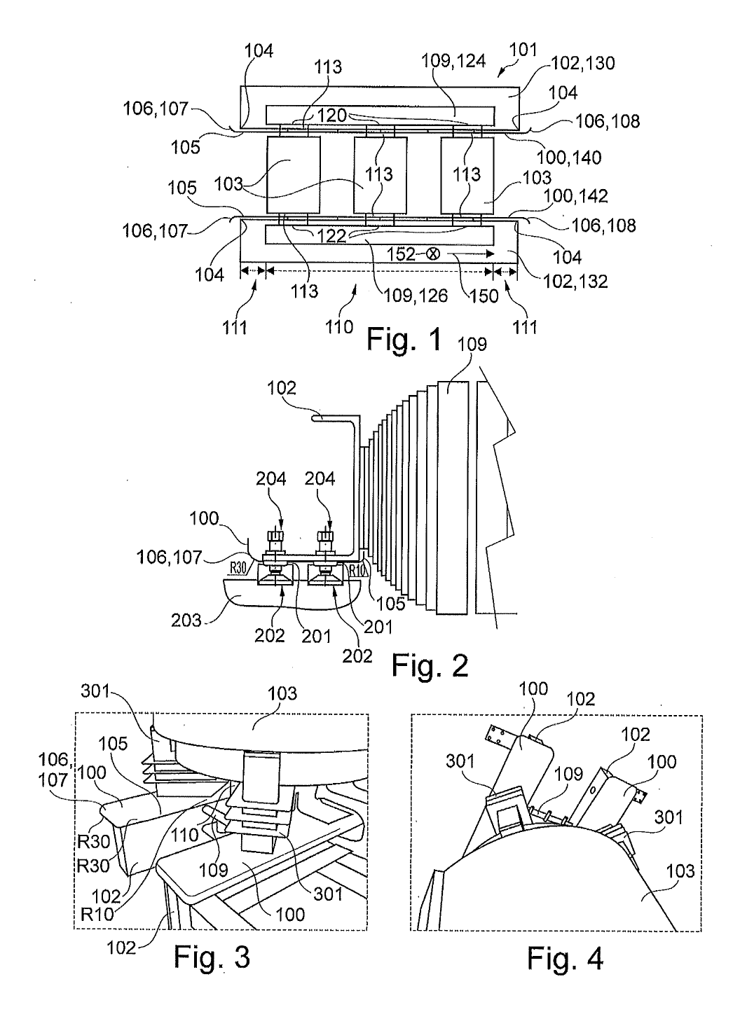

FIG. 1 schematically shows a cross-sectional view of an electric shielding arrangement for a transformer 101 including a clamp 102, 130, 132 attached at a yoke 109, 124, 126, and stabilizing the yoke 109, 124, 126 of the transformer 101. The transformer 101 also includes an electric shielding device 100, 140, 142 arranged at the clamp 102, 130, 132 between the yoke 109, 124, 126 and a winding 103 of the transformer 101. The electric shielding device 100, 140, 142 is configured to shield the clamp 102, 130, 132 from an electric field of the winding 103. The clamp 102, 130, 132 is configured to hold together and/or mechanically fix the yoke 109, 124, 126 of the transformer 101. The yoke 109, 124, 126 connects at least two limbs 113 of the transformer 101. The electric shield 100, 140, 142 may include rounded edges 105, 106.

The electric shielding device 100, 140, 142 may project over the edges 104 of the clamp 102, 130, 132.

The transformer 101 includes the above mentioned arrangement and at least two limbs 113, for example, three limbs 113, each including a first limb end 120 and a second limb end 122. A winding 103 is arranged around at least one of the at least two limbs 113, for example, a winding 103 is arranged at three limbs 113. A first yoke 109, 124 connects the three limbs 113 at the first limb ends 120. A second yoke 109, 126 connects the three limbs 113 at the second limb ends 122. The electric shielding arrangement includes first clamps 102, 130 attached at the first yoke 109, 124 to stabilize the first yoke 109, 124, and second clamps 102, 132 attached at the second yoke 109, 124 to stabilize the second yoke 109, 126. First electric shielding devices 100, 140 are arranged at the first clamps 102, 130 between the first yoke 109, 126, and three windings 103 each of the windings 103 arranged around each of the three limbs 113. Second electric shielding devices 100, 142 are arranged at the second clamps 102, 132 between the second yoke 109, 126 and the three windings 103.

First rounded edges 105 are arranged at a longitudinal side 150 of the clamp 102, 130, 132 facing the windings 103 of the transformer 101, wherein the windings 103 may be high voltage or low voltage windings. The longitudinal side 150 may be horizontal, and parallel to the yoke 109, 124, 126 limb 113 connecting side and perpendicular to the limbs 113 as indicated in FIG. 1. The first rounded edges 105 may arranged at edges 104 of the clamp 102, 130, 132 which may be metallic edges 104 related to the clamp 102, 130, 132.

The electric shielding device 100, 140, 142 may act as electrostatic shield to shield the sharp edges 104 of the clamp 102, 130, 132 itself and all other metallic edges 104 related to the clamp 102, 130, 132, thus smoothing the electric field of the transformer 101.

Second rounded edges 106 of the arrangement are arranged at the first end 107 and at the second end 108 of the electric shielding device 100, 140, 142 at a transverse side 152 of the clamp 102, 130, 132. The transverse side 152 may be horizontal, perpendicular to the longitudinal side 150 and to a vertical side parallel to the limbs 113.

The first or second rounded edges 105, 106 may have a radius of 10-45 mm, for example, 30 mm.

The first rounded edges 105 have a different radius at a first region 110 at a yoke 109, 109, 124, 126 of the transformer 101 then at a second region 111 that is not at the yoke 109, 124, 126. The electric shielding device 100, 140, 142 may be grounded by being connected to the clamp 102, 130, 132, for example by being welded to the clamp 102.

The first rounded edges 105 may have a length of ⅛ of a circumference of a sphere defined by the radius of the first rounded edges 105 or in other words the first rounded edges 105 may have a length of ⅛ of a sphere.

The transformer 101 may be a dry type transformer 101.

The electric shielding device 100, 140, 142 is arranged on all clamps 102 of the transformer 101, wherein the transformer 101 is configured to electrically shield the windings 103 which may be high voltage windings 103 or low voltage windings 103, or both, to the clamp 102, 130, 132.

The transformer 101 is applicable at a 72.5 kV level but may also be applicable at a level below or above 72.5 kV, for example.

FIG. 2 schematically shows a cross-sectional view of an electric shielding arrangement with a clamp 102 and an electric shielding device 100. The electric shielding device 100 includes rounded edges 105 which face a winding 103 of the transformer 101, wherein the clamp 102 is attached to a yoke 109 of the transformer 101. The electric shielding device 100 is configured to shield the clamp 102 from an electric field of the winding 103. The clamp 102 is configured to hold together and/or mechanically fix or stabilize a yoke 109 of the transformer 101.

The yoke 109 of a transformer is arranged at the clamp 102. The electric shielding device 100 may have the same function as the electric shielding device 100 of FIG. 1. First rounded edges 105 at edges of clamp 102 between the yoke 109 and the clamp 102 may be provided, having a radius of R10=10 mm facing the yoke 109, respectively at the yoke region of the transformer.

Second rounded edges 106 are arranged at a first end 107 of the electric shielding device 100 and have a radius of R30=30 mm.

The arrangement of FIG. 2 further includes holes 201 for placing support block inserts 202 and pressing bolts 204 of the transformer inside the holes, thereby fastening the support block 203 and the electric shielding device 100 to the clamp 102.

FIG. 3 schematically shows a perspective view of a bottom part of a transformer with a part of the clamp and shielding arrangement of FIG. 1. Windings 103, clamps 102 and the yoke 109 of a transformer are depicted.

Isolators 301 are arranged between the windings and the electric shielding devices 100 on top of the clamps 102.

The electric shielding devices 100 includes rounded edges 105 which face the windings 103 of the transformer 101 with a clamp 102 being attached to the transformer 101. First rounded edges 105 at edges of the clamp 102 face the windings 103 of the transformer and may have a radius of 10-45 mm.

Second rounded edges 106 at a first end 107 of the electric shielding device 100 are provided and may have a radius of about 30 mm, for example.

FIG. 4 schematically shows a top part of the transformer of FIG. 3 with two isolators 301 isolating the windings 103 from the clamps 102 with the rounded electric shielding devices 100.

While the present disclosure has been illustrated and described in detail in the drawings and the foregoing description, such illustration and description are to be considered illustrative or exemplary and not restricted; the disclosure is not limited to the disclosed embodiments.

Other variations of the disclosed embodiments may be understood and affected by those skilled in the art and practicing the present disclosure, from a study of the drawings, the disclosure, and the appended claims.

In the claims, the word “comprising” or “including” does not exclude other elements or steps, and the indefinite article “a” or “an” does not exclude a plurality. A single electric shielding arrangement, or a single transformer and a single clamp or a single electric shielding device may fulfill the function of several items recited in the claims. The mere fact that certain measures are recited in mutually different dependent claims does not indicate that a combination of these measures may not be used to advantage.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SIGNS

100 Electric shielding device
101 Transformer, dry transformer
102 Clamp(s)
103 Winding, high voltage winding, coil(s)
104 Edge(s), metallic edge(s)
105 Rounded edges, first rounded edges
106 Rounded edges, second rounded edges
107 First end (of the electric shielding device)
108 Second end (of the electric shielding device)
109 Yoke(s)
110 First region (at the yoke)
111 Second region (that is not at the yoke)
120 First limb end(s)
122 Second limb end(s)
124 First yoke
126 Second yoke
130 First clamp(s)
132 Second clamp(s)
140 First electric shielding device(s)
142 Second electric shielding device(s)
150 Longitudinal side (of the clamp)
152 Transverse side (of the clamp)
113 Limb(s)
201 Holes
202 Block inserts
203 Support block
204 Pressing bolts
301 Isolator, isolators
R10 Radius of 10 mm
R30 Radius of 30 mm

What is claimed is:

1. An electric shielding arrangement for a transformer, the arrangement comprising:
a clamp attached at a yoke of the transformer and configured to stabilize the yoke of the transformer; and
an electric shielding device arranged at the clamp, between the yoke and a winding of the transformer,
wherein the electric shielding device is configured to shield the clamp from an electric field of the winding.

2. The arrangement of claim 1, wherein the electric shielding device comprises rounded edges.

3. The arrangement of claim 2, wherein the rounded edges comprise:
first rounded edges at a longitudinal side of the clamp facing the winding of the transformer.

4. The arrangement of claim 2, wherein the rounded edges comprise:
second rounded edges at a first end and at a second end of the electric shielding device at a transverse side of the clamp.

5. The arrangement of claim 3, wherein the first rounded edges have a radius of 5 to 45 mm.

6. The arrangement of claim 3, wherein the first rounded edges have a different radius at a first region at the yoke of the transformer than at a second region that is not at the yoke.

7. The arrangement of claim 1, wherein the electric shielding device is grounded by being connected to the clamp.

8. The arrangement of claim 7, wherein the electric shielding device is welded to the clamp.

9. The arrangement of claim 3, wherein the first rounded edges have ⅛ of a circumference of a corresponding sphere defined by the radius of the first rounded edges.

10. The arrangement of claim 1, comprising:
holes for placing support block inserts and pressing bolts of the transformer.

11. The arrangement of claim 1, wherein the electric shielding device projects over edges of the clamp.

12. A transformer comprising:
an arrangement of claim 1;
at least two limbs;
a winding arranged around at least one of the at least two limbs; and
a first yoke connecting the at least two limbs.

13. The transformer of claim 12, wherein the transformer is a dry type transformer applicable at a 72.5 kV voltage level.

14. The transformer of claim 12, wherein the transformer is configured to electrically shield high voltage windings to the clamp.

15. The transformer of 12, comprising:
three limbs each including a first limb end and a second limb end, the first yoke connecting the three limbs at the first limb ends; and
a second yoke connecting the three limbs at the second limb end,
wherein the electric shielding arrangement comprises:
first clamps attached at the first yoke to stabilize the first yoke;
second clamps attached at the second yoke to stabilize the second yoke;
first electric shielding devices arranged at the first clamps between the first yoke and three windings each of the windings arranged around each of the three limbs; and
second electric shielding devices arranged at the second clamps between the second yoke and the three windings.

16. The arrangement of claim 3, wherein the rounded edges comprise:
second rounded edges at a first end and at a second end of the electric shielding device at a transverse side of the clamp.

17. The arrangement of claim 16, wherein at least one of the first rounded edges and the second rounded edges have a radius of 5 to 45 mm.

18. The arrangement of claim 17, wherein the at least one of the first rounded edges and the second edges have a radius of 30 mm.

19. The arrangement of claim 5, wherein the first rounded edges have a radius of 30 mm.

20. The arrangement of claim 5, wherein the first rounded edges have a different radius at a first region at the yoke of the transformer than at a second region that is not at the yoke.

21. The arrangement of claim 3, wherein the first rounded edges have ⅛ of a circumference of a corresponding sphere defined by the radius of the first rounded edges.

22. The arrangement of claim 4, wherein the second rounded edges have a radius of 5 to 45 mm.

23. The arrangement of claim 22, wherein the second rounded edges have a radius of 30 mm.

24. The transformer of claim 13, wherein the transformer is configured to electrically shield high voltage windings to the clamp.

25. The transformer of 24, comprising:
three limbs each including a first limb end and a second limb end, the first yoke connecting the three limbs at the first limb ends; and
a second yoke connecting the three limbs at the second limb end,
wherein the electric shielding arrangement comprises:
first clamps attached at the first yoke to stabilize the first yoke;
second clamps attached at the second yoke to stabilize the second yoke;
first electric shielding devices arranged at the first clamps between the first yoke and three windings each of the windings arranged around each of the three limbs; and
second electric shielding devices arranged at the second clamps between the second yoke and the three windings.

26. A transformer comprising:
an arrangement of claim 17;
at least two limbs;
a winding arranged around at least one of the at least two limbs; and
a first yoke connecting the at least two limbs.

27. The transformer of claim 26, wherein the transformer is a dry type transformer applicable at a 72.5 kV voltage level.

28. The transformer of claim 26, wherein the transformer is configured to electrically shield high voltage windings to the clamp.

29. The transformer of 28, comprising:
three limbs each including a first limb end and a second limb end, the first yoke connecting the three limbs at the first limb ends; and
a second yoke connecting the three limbs at the second limb end,
wherein the electric shielding arrangement comprises:
first clamps attached at the first yoke to stabilize the first yoke;
second clamps attached at the second yoke to stabilize the second yoke;
first electric shielding devices arranged at the first clamps between the first yoke and three windings each of the windings arranged around each of the three limbs; and
second electric shielding devices arranged at the second clamps between the second yoke and the three windings.
